(19) United States
(12) Patent Application Publication
(10) Pub. No.: US 2019/0009433 A1
(43) Pub. Date: Jan. 10, 2019

(54) MANUFACTURING METHOD OF COLOR DECORATIVE PLATE FOR INTEGRAL BATHROOM

(71) Applicant: SUZHOU COZY HOUSE EQUIPMENT CO., LTD, Jiangsu (CN)

(72) Inventors: Zhongyi Chen, Jiangsu (CN); Futao Hu, Jiangsu (CN)

(73) Assignee: SUZHOU COZY HOUSE EQUIPMENT CO., LTD, Jiangsu (CN)

(21) Appl. No.: 15/548,098

(22) PCT Filed: Jun. 27, 2017
(86) PCT No.: PCT/CN2017/090241

§ 371 Date: Sep. 24, 2018

(30) Foreign Application Priority Data
Jun. 23, 2017 (CN) 201710485121.3

(51) Int. Cl. B29B 15/10; B29B 7/82; B29C 43/50; B29D 7/01; C08L 67/07; C08K 5/00; C08K 5/11; C08K 5/14; C08K 5/5419; C08K 5/01

(52) U.S. Cl. CPC B29B 15/105; B29B 7/823; B29C 43/50; B29D 7/01; C08L 67/07; B29K 2105/0863; C08K 5/11; C08K 5/14; C08K 5/5419; C08K 5/01; C08K 5/0025

(57) ABSTRACT

The present invention discloses a manufacturing method of a color decorative plate for an integral bathroom. Firstly, a decorative fiber cloth is immersed and a surfacing material is prepared, wherein the steps include: adding various auxiliaries to an unsaturated polyester resin; uniformly mixing to form a resin paste, wherein the auxiliaries contain an initiator, a mold discharging agent, an accelerator, a coupling agent, a crosslinking monomer and cinnamene; uniformly coating the above resin paste on the decorative fiber cloth; precuring and drying at 105° C. to 130° C. to produce the surfacing material; then compression moulding; feeding a sheet molding compound (SMC) into a mould; and laying the surfacing material on the SMC in the mould for integral compression moulding. In the compression moulding process, a mold cavity is at an upper part and a mold core is at a lower part to prevent decorative patterns from deforming because the decorative fiber cloth is stretched due to the flow of the SMC and to avoid wrinkling the decorative fiber cloth. The SMC is used as a structural layer, and the surfacing material is attached to a surface of the structural layer. The patterns on the surface of a finished product have high clarity and brightness.

### TECHNICAL FIELD

The present invention relates to a production technology of a color decorative plate, and particularly relates to a manufacturing method of a color decorative plate for an integral bathroom.

### BACKGROUND TECHNOLOGY

An integral bathroom is a bathroom formed by combining many bathroom facilities through compression moulding, supporting installation and other modes. A bathtub and a toilet are delicate in design; a bottom plate, a ceiling and a bathroom door are integrally installed; and small parts such as a cosmetic mirror, an illumination lamp, a ventilating fan, a water faucet, a paper winder, a towel rack, a bath towel rack, etc. are also supplied. In addition, a set of integral bathroom also comprises complete upper and lower water conduit fittings and a complete set of installation parts. Compared with a traditional bathroom, an integral bathroom mainly has three advantages: 1) matter simplifying and time saving: the integral kitchen and toilet are well decorated through dry construction without sand and cement, and only screws and adhesives are used; installation time is half of a day to one day; a construction period is greatly shortened; 2) leakage prevention: the bathtub of the integral bathroom and the bottom plate are formed by compression moulding in one step without splicing gap, thereby fundamentally solving a problem of easy water leakage that troubles many families in ground of an ordinary toilet; and 3) good material: most of the bottom plate, a wallboard, the ceiling, the bathtub, etc. of the integral bathroom are made of SMC; and SMC is a material special for an aircraft and a spacecraft and has good characteristics of dense material, smooth and clean surface, heat insulation, heat preservation, aging prevention, long service life, etc.

At present, a decorative plate of the integral bathroom is pressed by the SMC. A front surface and a back surface of the decorative plate have the same color which is the color of the SMC. The decorative plate has a single color, and a color decorative plate having the same bright color as a wall surface cannot be made now.

### SUMMARY OF THE INVENTION

The purpose of the present invention is to overcome defects in the prior art, so as to provide a manufacturing method of a color decorative plate for an integral bathroom.

The purpose of the present invention is realized by the following technical solution:

A manufacturing method of a color decorative plate for an integral bathroom comprises the following steps:

1) preparing a decorative fiber cloth;

2) immersing the decorative fiber cloth and preparing a surfacing material;

steps of preparing the surfacing material comprise: adding various auxiliaries to an unsaturated polyester resin; uniformly mixing to form a resin paste, wherein the auxiliaries contain an initiator, a mold discharging agent, an accelerator, a coupling agent, a crosslinking monomer and cinnamene; if the mass of the unsaturated polyester resin is designated as 100 parts, then each auxiliary has the following respective mass part:

| | |
|---|---|
| initiator | 1-2 |
| mold discharging agent | 3-5 |
| accelerator | 1-2 |
| coupling agent | 2-4 |
| crosslinking monomer | 8-20 |
| cinnamene | 3-30 |

uniformly coating the above resin paste on the decorative fiber cloth; then precuring and drying at 105° C. to 130° C. to achieve 70%-90% of a curing degree of the resin paste to produce the surfacing material;

3) conducting compression moulding: firstly feeding a sheet molding compound (SMC) into a mould with a feeding area of 75%-95% of an orthographic projection area of a product; and then laying the surfacing material on the SMC in the mould for integral compression moulding, wherein in the compression moulding process, a mold cavity is at an upper part and a mold core is at a lower part to prevent decorative patterns from deforming because the decorative fiber cloth is stretched due to the flow of the SMC and to avoid wrinkling the decorative fiber cloth; and

after compression moulding, the SMC is used as a structural layer, and the surfacing material is attached to a surface of the structural layer.

Further, in the above manufacturing method of the color decorative plate for the integral bathroom, the mass of the decorative fiber cloth per square meter is 60-180 g, and the mass of the resin paste coated on the decorative fiber cloth per square meter is 60-120 g.

Further, in the above manufacturing method of the color decorative plate for the integral bathroom, the decorative fiber cloth is formed by directed or random non-woven fabric fibers.

Further, in the above manufacturing method of the color decorative plate for the integral bathroom, patterns are printed on the decorative fiber cloth.

Further, in the above manufacturing method of the color decorative plate for the integral bathroom, the SMC is formed by a resin base material and glass fibers dispersed in the resin base material.

Further, in the above manufacturing method of the color decorative plate for the integral bathroom, the unsaturated polyester resin is m-phenylene resin or vinyl resin.

Further, in the above manufacturing method of the color decorative plate for the integral bathroom, the initiator is tert-butyl peroxybenzoate, or tert-butyl peroxy-2-ethylhexanoate or a compound initiator system of tert-butyl peroxybenzoate and tert-butyl peroxy-2-ethylhexanoate, and a mass ratio of tert-butyl peroxybenzoate to tert-butyl peroxy-2-ethylhexanoate is (0.7-0.8): (0.3-0.2).

Further, in the above manufacturing method of the color decorative plate for the integral bathroom, the accelerator is an accelerator E4.

Further, in the above manufacturing method of the color decorative plate for the integral bathroom, the mold discharging agent is stearate or phosphate ester.

Further, in the above manufacturing method of the color decorative plate for the integral bathroom, the crosslinking monomer is trimethylolpropane triacrylate or ethylene glycol diacrylate.

Further, in the above manufacturing method of the color decorative plate for the integral bathroom, the coupling agent is a KH-570 silane coupling agent.

Compared with the prior art, the present invention has apparent advantages and beneficial effects specifically reflected as follows:

\textcircled{1} The manufacturing method of the color decorative plate in the present invention can be used for producing the color decorative plate with good apparent quality for use in an integral bathroom and an integral shower by means of the compression moulding procedure only; procedures are shorten, the cost is low and process control is relatively simple.

\textcircled{2} By adding the crosslinking monomer, when the decorative fiber cloth and the SMC are integrally pressed and moulded, the crosslinking monomer reacts with the unsaturated polyester resin in the SMC to enhance the firm degree of bonding. Meanwhile, through the addition of the crosslinking monomer, the decorative fibers have higher surface brightness and the product has a good surface effect.

\textcircled{3} Through the addition of the initiator and the accelerator in a reasonable proportion, the curing degree of the decorative fibers is controlled within a required range, thereby benefiting not only storage of the immersed decorative fibers, but also integral forming of the immersed decorative fibers and the SMC at the time of using the immersed decorative fibers.

\textcircled{4} Through the addition of the accelerator, the curing degree of the immersed adhesive layer of the decorative fiber cloth is increased.

\textcircled{5} The decorative fiber cloth formed by the directed or random non-woven fabric fibers is adopted. The decorative fiber cloth has the characteristics of moisture resistance, ventilation, flexibility, light weight, no combustion supporting, no toxin and stimulation, rich colors, recycling, etc.

### DETAILED DESCRIPTION OF THE EMBODIMENTS

To understand technical features, the purpose and effects of the present invention more clearly, specific embodiments are described in detail with reference to drawings.

A specific manufacturing process of the color decorative plate for the integral bathroom is as follows:

1) preparing a decorative fiber cloth, wherein the decorative fiber cloth is formed by directed or random non-woven fabric fibers, and patterns of different colors are printed on the decorative fiber cloth;

2) immersing the decorative fiber cloth and preparing a surfacing material;

steps of preparing the surfacing material comprise: adding various auxiliaries to an unsaturated polyester resin; uniformly mixing to form a resin paste, wherein the auxiliaries contain an initiator, a mold discharging agent, an accelerator, a coupling agent, a crosslinking monomer and cinnamene; if the mass of the unsaturated polyester resin is designated as 100 parts, then each auxiliary has the following respective mass part:

| | |
|---|---|
| initiator | 1-2 |
| mold discharging agent | 3-5 |
| accelerator | 1-2 |
| coupling agent | 2-4 |
| crosslinking monomer | 8-20 |
| cinnamene | 3-30 |

uniformly coating the above resin paste on the decorative fiber cloth, wherein the mass of the decorative fiber cloth per square meter is 60-180 g, and the mass of the resin paste coated on the decorative fiber cloth per square meter is 60-120 g; then precuring and drying at 105° C. to 130° C. to achieve 70%-90% of a curing degree of the resin paste to produce the surfacing material;

3) conducting compression moulding: firstly feeding a sheet molding compound (SMC) into a mould, wherein the SMC is formed by a resin base material and glass fibers dispersed in the resin base material and a feeding area is 75%-95% of an orthographic projection area of a product; and then laying the surfacing material on the SMC in the mould for integral compression moulding, wherein in the compression moulding process, a mold cavity is at an upper part and a mold core is at a lower part to prevent decorative patterns from deforming because the decorative fiber cloth is stretched due to the flow of the SMC and avoid wrinkling the decorative fiber cloth; and

after compression moulding, the SMC is used as a structural layer, and the surfacing material is attached to a surface of the structural layer.

The unsaturated polyester resin is m-phenylene resin or vinyl resin. The initiator is tert-butyl peroxybenzoate, or tert-butyl peroxy-2-ethylhexanoate or a compound initiator system of tert-butyl peroxybenzoate and tert-butyl peroxy-2-ethylhexanoate, and a mass ratio of tert-butyl peroxybenzoate to tert-butyl peroxy-2-ethylhexanoate is (0.7-0.8): (0.3-0.2). The accelerator is an accelerator E4. The mold discharging agent is stearate or phosphate ester. The crosslinking monomer is trimethylolpropane triacrylate or ethylene glycol diacrylate. The coupling agent is a KH-570 silane coupling agent.

### Embodiment 1

The color decorative plate for the integral bathroom is prepared according to the following steps:

1) a resin paste is prepared according to the following formulation (mass parts):

| | |
|---|---|
| resin base material: unsaturated polyester resin | 100 parts |
| initiator: tert-butyl peroxybenzoate (TBPB) | 1 part |
| mold discharging agent: phosphate ester | 3 parts |
| accelerator: E4 | 2 parts |
| coupling agent: silane coupling agent KH570 | 2 parts |
| crosslinking monomer: trimethylolpropane triacrylate | 8 parts |

After the above raw materials are uniformly mixed to produce the resin paste, 10 parts of cinnamene are added to adjust viscosity to appropriately dilute the resin paste.

The above resin paste is unformly coated on the decorative fiber cloth with a color texture; and the mass ratio of the resin paste to the decorative fiber cloth is about 1:1. The decorative fiber cloth coated with the resin paste is fed into a drying tunnel of about 135° C. for precuring to ensure the curing degree achieves about 80% to produce decorative fiber material with a color surface for the compression moulding of the decorative plate;

2) a SMC is prepared according to the following formulation (mass parts):

| | |
|---|---|
| unsaturated polyester resin: m-phenylene resin | 80 parts; |
| low shrinkage additive: polymethylmethacrylate | 20 parts; |
| inorganic filler: calcium carbonate | 30 parts; |
| chopped glass fiber: | 20 parts; |
| initiator: tert-butyl peroxybenzoate (TBPB) | 1 part; |
| mold discharging agent: zinc stearate | 4 parts; |
| thickener: magnesia | 1.2 parts; |

The above raw materials are uniformly mixed to produce a paste material.

The above paste material is uniformly coated on an upper PE film and a lower PE film through a scraper; glass fibers are cut by adjusting a cutter, and length and content of the glass fibers are controlled; an upper paste material layer and a lower paste material layer are pasted oppositely; the glass fibers are placed between two paste material layers to form a sheet material coated with the PE films on an upper part and a lower part; the sheet material is extruded through a compactor to fully immerse the sheet material to form the sheet material; then the sheet material is coiled;

the coiled sheet material is delivered to a thickening chamber for thickening; the temperature of the thickening chamber is 45° C.; the thickening time is 24 hours; and the SMC is obtained.

3) compression moulding is conducted: feeding the SMC into a mould with a feeding area of 75%-95% of an orthographic projection area of a product; then laying the surfacing material on the SMC in the mould for integral compression moulding, wherein in the compression moulding process, a mold cavity is at an upper part and a mold core is at a lower part, temperatures of the mold cavity and the mold core of the mould are respectively 145° C. and 138° C., compression moulding pressure is selected as 40 kg/m², molding time is 125 seconds and the thickness of a final product is 2 mm; trimming after completing compression moulding; and finishing flash and burr around the product.

The patterns on the surface of the obtained finished product have high clarity and brightness.

### Embodiment 2

1) a resin paste is prepared according to the following formulation (mass parts):

| | |
|---|---|
| resin base material: vinyl resin | 100 parts |
| initiator: tert-butyl peroxybenzoate (TBPB) | 2 parts |
| mold discharging agent: phosphate ester | 5 parts |
| accelerator: E4 | 1 part |
| coupling agent: silane coupling agent KH570 | 2 parts |
| crosslinking monomer: trimethylolpropane triacrylate | 20 parts |

After the above raw materials are uniformly mixed to produce the resin paste, 18 parts of cinnamene are added to adjust viscosity to appropriately dilute the resin paste.

The above resin paste is unformly coated on the decorative fiber cloth with a color texture; and the mass ratio of the resin paste to the decorative fiber cloth is about 1:1. The decorative fiber cloth coated with the resin paste is fed into a drying tunnel of about 135° C. for precuring to ensure the curing degree achieves about 80% to produce decorative fiber material with a color surface for the compression moulding of the decorative plate;

2) a SMC is prepared according to the following formulation (mass parts):

| | |
|---|---|
| unsaturated polyester resin: m-phenylene resin | 80 parts; |
| low shrinkage additive: polymethylmethacrylate | 20 parts; |
| inorganic filler: calcium carbonate | 30 parts; |
| chopped glass fiber: | 20 parts; |
| initiator: tert-butyl peroxybenzoate (TBPB) | 1 part; |
| mold discharging agent: zinc stearate | 4 parts; |
| thickener: magnesia | 1.2 parts; |

The above raw materials are uniformly mixed to produce a paste material.

The above paste material is uniformly coated on an upper PE film and a lower PE film through a scraper; glass fibers are cut by adjusting a cutter, and length and content of the glass fibers are controlled; an upper paste material layer and a lower paste material layer are pasted oppositely; the glass fibers are placed between two paste material layers to form a sheet material coated with the PE films on an upper part and a lower part; the sheet material is extruded through a compactor to fully immerse the sheet material to form the sheet material; then the sheet material is coiled;

the coiled sheet material is delivered to a thickening chamber for thickening; the temperature of the thickening chamber is 45° C.; the thickening time is 24 hours; and the SMC is obtained.

3) compression moulding is conducted: feeding the SMC into a mould with a feeding area of 75%-95% of an orthographic projection area of a product; then laying the surfacing material on the SMC in the mould for integral compression moulding, wherein in the compression moulding process, a mold cavity is at an upper part and a mold core is at a lower part, temperatures of the mold cavity and the mold core of the mould are respectively 145° C. and 138° C., compression moulding pressure is selected as 40 kg/m², molding time is 125 seconds and the thickness of a final product is 2 mm; trimming after completing compression moulding; and finishing flash and burr around the product.

The patterns on the surface of the obtained finished product have high clarity and brightness.

### Embodiment 3

1) a resin paste is prepared according to the following formulation (mass parts):

| | | |
|---|---|---|
| resin base material: vinyl resin | 100 | parts |
| initiator: tert-butyl peroxybenzoate (TBPB) | 1.5 | parts |
| mold discharging agent: phosphate ester | 3.5 | parts |
| accelerator: E4 | 1.5 | parts |
| coupling agent: silane coupling agent KH570 | 2 | parts |
| crosslinking monomer: trimethylolpropane triacrylate | 20 | parts |

After the above raw materials are uniformly mixed to produce the resin paste, 15 parts of cinnamene are added to adjust viscosity to appropriately dilute the resin paste.

The above resin paste is unformly coated on the decorative fiber cloth with a color texture; and the mass ratio of the resin paste to the decorative fiber cloth is about 1:1. The decorative fiber cloth coated with the resin paste is fed into a drying tunnel of about 135° C. for precuring to ensure the curing degree achieves about 80% to produce decorative fiber material with a color surface for the compression moulding of the decorative plate;

2) a SMC is prepared according to the following formulation (mass parts):

| | |
|---|---|
| unsaturated polyester resin: m-phenylene resin | 80 parts; |
| low shrinkage additive: polymethylmethacrylate | 20 parts; |
| inorganic filler: calcium carbonate | 30 parts; |
| chopped glass fiber: | 20 parts; |
| initiator: tert-butyl peroxybenzoate (TBPB) | 1 part; |
| mold discharging agent: zinc stearate | 4 parts; |
| thickener: magnesia | 1.2 parts; |

The above raw materials are uniformly mixed to produce a paste material.

The above paste material is uniformly coated on an upper PE film and a lower PE film through a scraper; glass fibers are cut by adjusting a cutter, and length and content of the glass fibers are controlled; an upper paste material layer and a lower paste material layer are pasted oppositely; the glass fibers are placed between two paste material layers to form a sheet material coated with the PE films on an upper part and a lower part; the sheet material is extruded through a compactor to fully immerse the sheet material to form the sheet material; then the sheet material is coiled;

the coiled sheet material is delivered to a thickening chamber for thickening; the temperature of the thickening chamber is 45° C.; the thickening time is 24 hours; and the SMC is obtained.

3) compression moulding is conducted: feeding the SMC into a mould with a feeding area of 75%-95% of an orthographic projection area of a product; then laying the surfacing material on the SMC in the mould for integral compression moulding, wherein in the compression moulding process, a mold cavity is at an upper part and a mold core is at a lower part, temperatures of the mold cavity and the mold core of the mould are respectively 145° C. and 138° C., compression moulding pressure is selected as 40 kg/m², molding time is 125 seconds and the thickness of a final product is 2 mm; trimming after completing compression moulding; and finishing flash and burr around the product.

The patterns on the surface of the obtained finished product have high clarity and brightness.

Test results of the above embodiments are shown in Table 1.

TABLE 1

| | Embodiments | | |
|---|---|---|---|
| Performance | Embodiment 1 | Embodiment 2 | Embodiment 3 |
| Stripping | After immersing for | After immersing for | After immersing for |
| performance | 24 hours in warm | 24 hours in warm | 24 hours in warm |
| | water of 80° C., | water of 80° C., | water of 80° C., |
| | stripping is conducted | stripping is | stripping is |
| | while hot and the | conducted while hot | conducted while hot |
| | surfacing material is | and the surfacing | and the surfacing |
| | not separated from the | material is not | material is not |
| | structural layer | separated from the | separated from the |
| | | structural layer | structural layer |
| Acid and alkali | After coating a test | After coating a test | After coating a test |
| resistance | surface for 1 hour | surface for 1 hour | surface for 1 hour |
| | with HCl solution of a | with HCl solution of | with HCl solution of |
| | 3% concentration and | a 3% concentration | a 3% concentration |
| | cleaning, no crack and | and cleaning, no | and cleaning, no |
| | inflation exist on the | crack and inflation | crack and inflation |
| | surface, barcol | exist on the surface, | exist on the surface, |
| | hardness is 48 and a | barcol hardness is 48 | barcol hardness is 48 |
| | color difference ΔE is | and a color | and a color |
| | 1.0 | difference ΔE is 1.1 | difference ΔE is 0.9 |
| Boiling | After immersing for | After immersing for | After immersing for |
| resistance | 24 hours in warm | 24 hours in warm | 24 hours in warm |
| | water of 80° C., no | water of 80° C., no | water of 80° C., no |
| | crack and bump exist | crack and bump exist | crack and bump exist |
| Pollution | After mixing | After mixing | After mixing |
| resistance | petrolatum and carbon | petrolatum and | petrolatum and |
| | black (9:1), coating | carbon black (9:1), | carbon black (9:1), |
| | for 30 minutes and | coating for 30 | coating for 30 |
| | cleaning, a recovery | minutes and | minutes and |
| | rate is determined as | cleaning, a recovery | cleaning, a recovery |
| | 96 and a color | rate is determined as | rate is determined as |
| | difference Δ E is | 98 and a color | 98 and a color |
| | determined as 0.8 | difference Δ E is | difference Δ E is |
| | | determined as 0.7 | determined as 0.6 |
| Glossiness | 88 | 95 | 95 |
| (GU) | | | |

By adding the crosslinking monomer, when the decorative fiber cloth and the SMC are integrally pressed and moulded, the crosslinking monomer reacts with the unsaturated polyester resin in the SMC to enhance the firm degree of bonding. Meanwhile, through the addition of the crosslinking monomer, the decorative fibers have higher surface brightness and the product has a good surface effect.

8-20 parts of the crosslinking monomer are added. If less than 8 parts of the crosslinking monomer are added, the obtained product has poor surface brightness and low bonding strength. If more than 20 parts of the crosslinking monomer are added, the obtained surfacing material has excessively high hardness, and surfacing crack is easy to occur in the compression moulding process, causing bad phenomena such as surface crack of the product, etc.

Through the addition of the initiator and the accelerator in a reasonable proportion, the curing degree of the decorative fibers is controlled within a required range, thereby benefiting not only storage of the immersed decorative fibers, but also integral forming of the immersed decorative fibers and the SMC at the time of using the immersed decorative fibers.

The E4 accelerator is selected as the accelerator, and is a novel accelerator prepared by using cobalt iso-octoate and cinnamene as major raw materials. The accelerator has high purity, good color and luster and high cobalt content, and is widely suitable for various glass fiber reinforced polyester products, gel coat, artificial marble, etc. Through the addition of the accelerator, the curing degree of an immersed adhesive layer of the decorative fiber cloth can be increased. Because the density of the decorative fiber cloth is not as good as decorative paper, if the curing degree is insufficient, when integral compression moulding with the SMC is conducted, the SMC on a back surface may pass through the decorative fiber cloth to reach the surface of the decorative plate, thereby covering the surface texture of the decorative fiber cloth to generate an unqualified product.

The decorative fiber cloth formed by the directed or random non-woven fabric fibers is adopted. Since the decorative fiber cloth is formed by the fibers, the decorative fiber cloth is called a fiber cloth. The fiber cloth is a new generation of environmental protection material and has the characteristics of moisture resistance, ventilation, flexibility, light weight, no combustion supporting, no toxin and stimulation, rich colors, recycling, etc. If polyester granules are mainly used as raw materials, the decorative fiber cloth is produced through a continuous one-step method of high temperature melting, spinning, steel laying and hot-rolling coiling. The decorative fiber cloth is called cloth due to an appearance of cloth and some properties.

Non-woven fabric is a kind of non-weaving cloth which is non-braided fabric formed by enabling fibers to form a net through an air flow or a machine directly using polymer slices, short fibers or filaments, then reinforcing through spunlace, needling or hot rolling and finally after-finishing. The non-woven fabric is a novel fiber product with a soft, ventilating and planar structure, has the advantages of no generation of fiber flock, toughness, durability and silky softness, and is one of reinforcing materials. The non-woven fabric also brings a cottony feeling, is made of 100% fibers and has good porosity and air permeability. No toxin and stimulation: The product is produced by food grade ingredients that conform to FDA, is free of other chemical components, and has stable performance, no toxin and no peculiar smell. Bacteria and chemicals resistance: the product belongs to chemically passive substances, has no damage by worms and can isolate erosion by bacteria and insects in liquid. Bacteria resistance and alkali corrosion resistance ensure that the finished product is not affected in strength due to erosion. The product has water-repellent property, does not get mildew, can isolate erosion by bacteria and insects in liquid, has no damage by mildew, and has good physical property. The product is formed by spinning high polymers such as polyester, etc., directly laying into a net and conducting thermal bonding. The product has better strength than a general chopped fiber product. The strength is nondirectional and longitudinal strength and transverse strength are close.

In conclusion, the manufacturing method of the color decorative plate in the present invention can be used for producing the color decorative plate with good apparent quality for use in an integral bathroom and an integral shower by means of the compression moulding procedure only.

1. A manufacturing method of a color decorative plate for an integral bathroom, comprising:
1) preparing a decorative fiber cloth;
2) immersing the decorative fiber cloth and preparing a surfacing material, wherein preparing the surfacing material comprises:
adding various auxiliaries to an unsaturated polyester resin;
uniformly mixing to form a resin paste, wherein the auxiliaries contain an initiator, a mold discharging agent, an accelerator, a coupling agent, a crosslinking monomer and a cinnamene, wherein based on 100 parts by weight of the unsaturated polyester resin, a content of the initiator is 1 to 2 parts by weight, a content of the mold discharging agent is 3 to 5 parts by weight, a content of the accelerator is 1 to 2 parts by weight, a content of the coupling agent is 2 to 4 parts by weight, a content of the crosslinking monomer is 8 to 20 parts by weight, and a content of the cinnamene is 3 to 30 parts by weight;
uniformly coating the above resin paste on the decorative fiber cloth; and
precuring and drying at 105° C. to 130° C. to achieve 70%-90% of a curing degree of the resin paste to produce the surfacing material; and
3) conducting compression moulding, wherein conducting compression moulding comprises:
feeding a sheet molding compound into a mould with a feeding area of 75%-95% of an orthographic projection area of a product; and
laying the surfacing material on the sheet molding compound in the mould for an integral compression moulding,
wherein in the compression moulding process, a mold cavity is at an upper part and a mold core is at a lower part to prevent decorative patterns from deforming because the decorative fiber cloth is stretched due to a flow of the sheet molding compound and to avoid wrinkling the decorative fiber cloth, and
wherein the sheet molding compound is used as a structural layer, and the surfacing material is attached to a surface of the structural layer.

2. The manufacturing method of the color decorative plate for the integral bathroom according to claim 1, wherein an amount of the decorative fiber cloth per square meter is 60-180 g, and an amount of the resin paste coated on the decorative fiber cloth per square meter is 60-120 g.

3. The manufacturing method of the color decorative plate for the integral bathroom according to claim 1, wherein the decorative fiber cloth is formed by directed or random non-woven fabric fibers.

4. The manufacturing method of the color decorative plate for the integral bathroom according to claim 1, wherein patterns are printed on the decorative fiber cloth.

5. The manufacturing method of the color decorative plate for the integral bathroom according to claim 1, wherein the sheet molding compound is formed by a resin base material and glass fibers dispersed in the resin base material.

6. The manufacturing method of the color decorative plate for the integral bathroom according to claim 1, wherein the unsaturated polyester resin is m-phenylene resin or vinyl resin.

7. The manufacturing method of the color decorative plate for the integral bathroom according to claim 1, wherein the initiator is tert-butyl peroxybenzoate, tert-butyl peroxy-2-ethylhexanoate, or a compound initiator system of tert-butyl peroxybenzoate and tert-butyl peroxy-2-ethylhexanoate, and wherein in the compound initiator system of tert-butyl peroxybenzoate and tert-butyl peroxy-2-ethylhexanoate, a mass ratio of tert-butyl peroxybenzoate to tert-butyl peroxy-2-ethylhexanoate is from 0.7:0.3 to 0.8:0.2.

8. The manufacturing method of the color decorative plate for the integral bathroom according to claim 1, wherein the accelerator is an accelerator E4.

9. The manufacturing method of the color decorative plate for the integral bathroom according to claim 1, wherein the mold discharging agent is stearate or phosphate ester.

10. The manufacturing method of the color decorative plate for the integral bathroom according to claim 1, wherein the crosslinking monomer is trimethylolpropane triacrylate or ethylene glycol diacrylate.

11. The manufacturing method of the color decorative plate for the integral bathroom according to claim 1, wherein the coupling agent is a KH-570 silane coupling agent.

12. The manufacturing method of the color decorative plate for the integral bathroom according to claim 2, wherein the decorative fiber cloth is formed by directed or random non-woven fabric fibers.

13. The manufacturing method of the color decorative plate for the integral bathroom according to claim 2, wherein patterns are printed on the decorative fiber cloth.
